(19) United States
(12) Patent Application Publication
(10) Pub. No.: US 2004/0184791 A1
(43) Pub. Date: Sep. 23, 2004

(54) Closed loop feedback method for electric motor

(75) Inventor: Thomas G. Guyett, Gainesville, GA (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: Sunbeam Products, Inc., Boca Raton, FL

(21) Appl. No.: 10/394,979

(22) Filed: Mar. 21, 2003

(51) Int. Cl. H02P 5/00

(52) U.S. Cl. 388/800

(57) ABSTRACT

A circuit for providing feedback regarding the torque on an AC electric motor. A sample and hold circuit provides DC voltage information regarding the voltage drop across a resistor wired in series with the windings of the motor. Reference voltage from the sample and hold circuit may be supplied to a comparator, such as an operational amplifier, along with a voltage reading from a fixed rate charging circuit. A pulse is provided to a microcontroller each time the voltage of the fixed rate charging circuit equals the reference voltage, and the fixed rate charging circuit is discharged. The microcontroller uses the frequency of the pulses to determine the load on the motor.

### TECHNICAL FIELD OF THE INVENTION

The present invention is generally directed to electric motors, and more particularly to a circuit for providing feedback regarding a load on an electric motor.

### BACKGROUND OF THE INVENTION

For many applications in which an electric motor is used, it may be desired for the motor to operate at a substantially constant speed. However, a load placed on the motor may cause the motor to slow down and a work shaft to turn more slowly. To this end, the rotation of an electric motor shaft provides direct feedback as to the load on the electric motor. This information may be provided to the controls for the motor (e.g., a triac), so that current to the electric motor may be increased to compensate for the increased load and to attempt to maintain a constant speed.

One method of measuring rotational speed of an electric motor shaft is the use of a Hall Effect transistor mounted in close proximity to a rotating magnet coupled to the shaft of the motor. The transistor provides a pulse for each rotation of the motor, and the temporal proximity of the pulses is directly related to the rotational speed of the shaft. A Hall Effect transistor is relatively expensive, and requires some type of magnetic pick-up mounted to the rotor, which may also be costly.

Another method of measuring load on a DC electric motor involves the use of a load resistor placed in series with the motor windings. As is known, when a load is placed on a motor, the rotor will attempt to keep up with the alternating fields, and current will increase through the windings. As current is increased to the windings to maintain motor speed, a voltage drop occurs across the load resistor. Traditionally, an op-amp is used to amplify the voltage across the load resistor. In the prior art, this corresponding voltage is measured at the zero-crossing point to analyze the inductive effect of motor loading. The analog to digital input of the microcontroller reads the op-amp amplified voltage drop across the load resistor at the instance of the zero-crossing. The firing phase of the TRIAC is then recalculated to compensate the speed correction. Such a microcontroller with an integrated analog to digital converter is quite expensive. Often, the use of such microcontrollers for low cost motors may be cost prohibitive.

### SUMMARY OF THE INVENTION

The present invention provides an inexpensive circuit for providing feedback regarding the torque on or speed of an AC electric motor. The circuit can operate without the need of an analog to digital converter. The feedback can be interpreted without the need to measure only at the zero-crossing. In addition, the circuit may provide information regarding load on the motor without the use of a Hall Effect switch or other type of magnetically induced signal.

In accordance with one aspect of the invention, a comparator, such as an operational amplifier, is fed two signals. The first signal is a fixed rate charging circuit which exhibits a relatively constant rise in voltage. This signal is fed to one input of the comparator. The other signal is a variable voltage signal which is fed into the other input of the comparator. The variable voltage signal is directly related to current flowing through a load resistor that is mounted in series with the windings of the motor, which, in turn, is proportional to the torque on the motor. The voltage drop across the load resistor determines the value of the variable voltage supplied to the comparator. This voltage is provided as a reference voltage to the comparator.

In accordance with one aspect of the present invention, the reference voltage is provided to the comparator via a sample and hold circuit. The sample and hold circuit stabilizes AC voltage information across the load resistor (i.e., voltage drop changes are smoothed). In addition, the sample and hold circuit provides information about the voltage drop in the form of a DC voltage converted from the AC voltage.

The voltage of the fixed rate charging circuit increases linearly until it reaches a value that is related to the reference voltage (e.g., equal to the reference voltage). When the fixed rate charging circuit voltage rises to that reference voltage value, the comparator produces an output to an input pin on the microcontroller, in the form of a pulse. The microcontroller then discharges the fixed rate charging circuit, for example via an output pin on the microcontroller. The voltage of the fixed rate charging circuit begins to rise again until the voltage of the fixed rated charging circuit reaches the current reference voltage value, which may have changed as a result of increased or decreased motor load. Another pulse is then generated and sent to the microcontroller, and the fixed rate charging circuit is discharged again. This process continues, producing a series of pulses that are supplied to the microcontroller.

The pulses generated by the comparator are more frequent as the reference voltage drops, because the fixed rate charging circuit does not take as long to raise its voltage to the reference voltage value. Thus, by using the time between the pulses, the microcontroller is informed of the speed of the motor shaft and the load on the motor. Using this information, the output of the motor may be adjusted by the motor controls so as to address low torque or high torque motor situations.

In an alternative embodiment, a voltage controlled oscillator may be connected directly to the sample and hold circuit. As the reference voltage increases or decreases, the voltage controlled oscillator outputs a square-wave with varying frequency. The microcontroller can detect the frequency on an input pin to determine if the torque on the motor is increasing or decreasing. (0011) Other advantages will become apparent from the following detailed description when taken in conjunction with the drawings, in which:

### BRIEF DESCRIPTION OF THE DRAWINGS

FIG. 1 is a block diagram showing a motor and related controls in accordance with one aspect of the present invention;

FIG. 2 is a circuit diagram of a control circuit for the motor of FIG. 1;

FIG. 3 is a graph representing voltage versus time for a fixed rate charging circuit for use in the circuit of FIG. 2, the graph representing a motor being off;

FIG. 4 is a graph representing voltage versus time for a fixed rate charging circuit for use in the circuit of FIG. 2, the graph representing a no-load situation for a motor;

FIG. 5 is a graph representing voltage versus time for a fixed rate charging circuit for use in the circuit of FIG. 2, the graph representing a loaded situation for a motor;

FIG. 6 is a circuit diagram of alternate embodiment of a control circuit for the motor of FIG. 1; and

FIG. 7 is a circuit diagram of another alternate embodiment of a control circuit for the motor of FIG. 1.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention

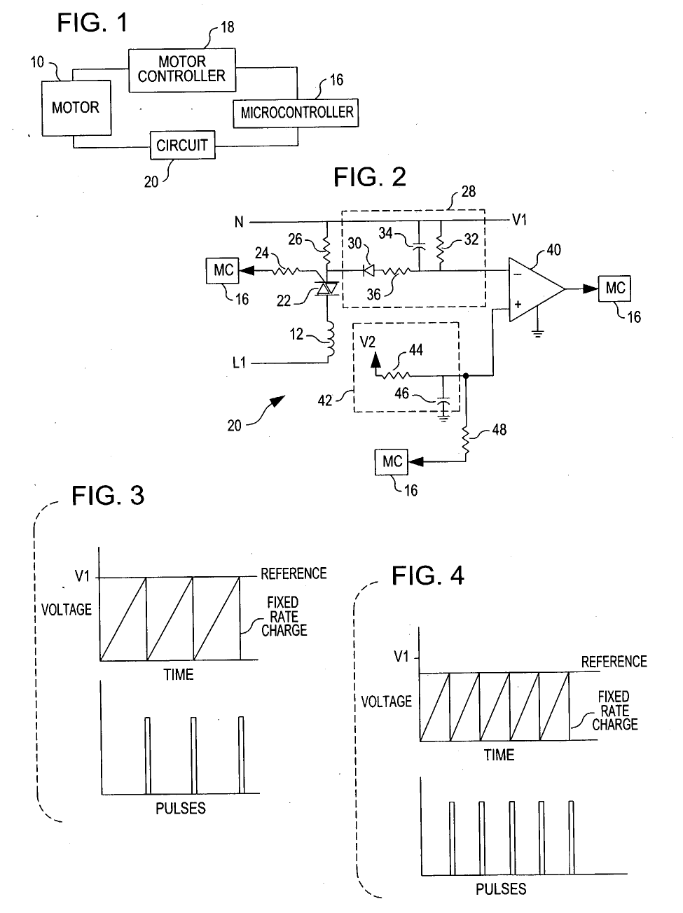

Referring now to the drawings, in which like reference numerals represent like parts throughout the several views, FIG. 1 shows an electric motor 10 that includes a speed-sensing circuit 20 (best shown in FIG. 2) in accordance with the present invention. The electrical motor 10 is preferably an alternating current (AC) motor, or may be a universal motor, which is designed so that it may be used on either an alternating current or direct current supply. The electric motor 10 includes windings 12 mounted on the stator (not shown, but known in the art) of the electric motor.

As further described below, the circuit 20 is connected to the windings 12 and supplies information regarding torque or motor speed of the motor 10 to a microcontroller 16. The microcontroller 16 may, in return, provide information to a power controller 18, such as a triac, configured to control the power supplied to the electrical motor 10.

The microcontroller 16 and the power controller 18 may each be a standard control (i.e., a device or mechanism used to regulate or guide the operation of a machine, apparatus, or system), a microcomputer, or any other device that can execute computer-executable instructions, such as program modules. Generally, program modules include routines, programs, objects, components, data structures and the like that perform particular tasks or implement particular abstract data types. A programmer of ordinary skill in the art can program or configure the microcontroller 16 and the power controller 18 to perform the functions described herein.

FIG. 2 shows the circuit 20 in detail. The windings 12 are wired in series with the power controller 18 and a resistor 26, hereinafter referred to as the “load resistor 26.” A second resistor 24 is also wired between the power controller 18 and a pin (not shown) of the microcontroller 16. This connection permits the microcontroller to properly instruct the power controller 18 to increase or decrease power to the electric motor 10.

A sample and hold circuit 28 is coupled to the load resistor 26. The sample and hold circuit 28 includes a diode 30, a resistor 32, and a capacitor 34. A second resistor 36 may be provided for protection of the diode 30. A DC voltage V1, such as 5 volts, is applied to the juncture of the load resistor 26 and the resistor 32 of the sample and hold circuit 28. The voltage drop across the resistor 32 is supplied to a first input of a comparator 40, shown in the drawings as an operational amplifier, and which may be built as part of an integrated circuit, for example. For ease of reference, this voltage input from the sample and hold circuit 28 to the first input of the comparator 40 is hereinafter referred to as a “reference voltage” for the circuit 20.

As is known, a sample and hold circuit, such as the sample and hold circuit 28, samples and holds an analog signal for a finite period of time. Typically, sample and holds circuits are used to precede an analog to digital converter, allowing time for conversion. In the present invention, the sample and hold circuit holds a voltage reading at the opposite side of the resistor 32 from the voltage V1, and provides the value it obtains as a constant output that may change over various situations. The capacitor 34 keeps the change in voltage samples substantially smooth, and the diode 30 causes the current to flow only one way through the sample and hold circuit 28.

In the sample and hold circuit 28 shown in FIG. 2, the voltage samples across the resistor 32 are equal to the voltage V1 minus the voltage drop on the load resistor 26. Thus, the reference voltage varies directly with changes in voltage drop (i.e., current flow) through the load resistor 26.

The opposite input for the comparator 40 is a fixed rate charging circuit 42, including a resistor 44 and a capacitor 46. This input of the comparator 40 is connected to the juncture of the capacitor 46 and the resistor 44 of the fixed rate charging circuit 42. Voltage V2 is applied to the opposite side of the resistor 44. The voltage V2 may be any desired DC voltage, as long as it is greater than or equal to the voltage V1. As is known, a fixed rate charging circuit, such as the fixed rate charging circuit 42, when provided a constant voltage source, such as the voltage V2 in FIG. 2, will experience a relatively constant rise in voltage. Other components or systems may be used in the place of the fixed rate charging circuit 42, but the shown embodiment is an inexpensive way of providing a circuit that has a relatively constant rise in voltage.

A resistor 48 is also attached at the juncture of the resistor 44 and the capacitor 46, and an output pin of the microcontroller 16. The function of this resistor 48 is further described below.

In operation, a voltage is applied across the windings 12 and, in turn, the load resistor 26. The sample and hold circuit 28 provides voltage information to the first side of the comparator 40.

In general, a motor turning at a given no-load speed will develop a repeatable voltage drop across a load resistor such as the load resistor 26. As the motor is loaded with excessive torque, the voltage across the load resistor 26 rises substantially linearly with respect to its no-load voltage as the current through the windings 12 and the load resistor 26 increases. Thus, the voltage drop, or the change in voltage drop, is directly proportional to the torque, or change in torque, on the motor.

When the electric motor 10 is off, the only current flowing through the resistor 32 is the voltage V1, e.g., 5 volts. Thus, the voltage reading at the first input of the comparator is V1 volts at this level. When the electric motor 10 is turned on, current flows through the windings 12 and the load resistor 26. The reference voltage is shown at V1 in FIG. 3.

At the same time that voltage information is provided by the sample and hold circuit 28 to the comparator 40, the voltage of the fixed rate charging circuit 42 rises at a fixed rate. In accordance with the present invention, when the voltage supplied by the fixed rate charging circuit 42 to the comparator 40 is equal to the reference voltage supplied by the sample and hold circuit 28, a pulse is provided by the comparator 40. This pulse is provided to an input pin on the microcontroller 16. When provided this pulse, the microcontroller 16 closes the circuit for the resistor 48, thus discharging the fixed rate charging circuit 42 back to zero. The fixed rate charging circuit 42 then begins charging again to the new reference voltage, which may or may not be different than the previous reference voltage, depending upon whether the torque load on the motor has changed.

Although the disclosed embodiment is described with respect to the comparator 40 issuing a pulse when the fixed rate charging circuit 42 reaches the reference voltage, the comparator may be configured to issue a pulse when the fixed rate charging circuit 42 reaches any defined value relative to the reference voltage. As nonlimiting examples, a pulse may be issued when the voltage of the fixed rate charging circuit 42 equals double the reference voltage, one half the reference voltage, or the reference voltage plus one. In addition, the fixed rate charging circuit 42 does not have to discharge to zero volts, but may instead discharge to another voltage.

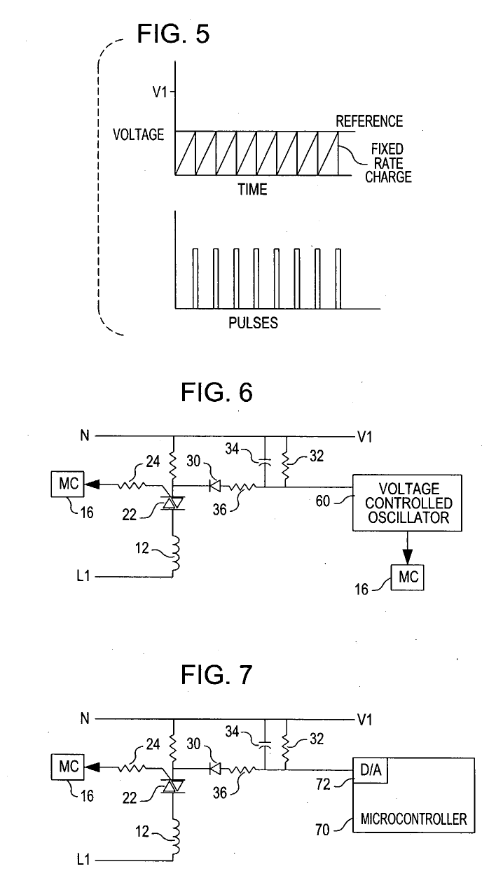

A graph of voltage versus time for the fixed rate charging circuit 42 with the motor off is shown in FIG. 3. For this example and the examples in FIGS. 4 and 5, V1 is 5 volts. As can be seen, the voltage for the fixed rate charging circuit 42 increases until it reaches the reference voltage and then drops (i.e., is discharged) to zero, increases at the same rate to the reference voltage, and then again drops to zero. Each time the voltage of the fixed rate charging circuit 42 reaches the reference voltage, the comparator 40 sends a voltage pulse to the microcontroller.

The graph in FIG. 4 represents a no-load situation in which the electric motor 10 is operating with no load against its shaft. In the present example, the current through the load resistor 26 causes the voltage drop across the resistor 32 to decrease to four volts. Again, the voltage for the fixed rate charging circuit 42 increases until it reaches the reference voltage (now 4) and then drops (i.e., is discharged) to zero and repeats this process. This continues, and a pulse is supplied to the microcontroller 16 each time the voltage of the fixed rated charging circuit 42 is equal to the reference voltage.

As torque is applied to the electric motor 10, the current increases across the load resistor 26, decreasing the reference voltage, such as shown in FIG. 5. The fixed rate charging circuit continues to function in the same manner, but the number of pulses for a given time period increases because the amount that the voltage has to increase to reach the reference voltage is decreased. Thus, the pulses supplied to the microcontroller 16 are more frequent.

The microcontroller 16 may utilize the frequency of the pulses to provide information to the power controller 18 for the motor 10. The power controller 18 may utilize this information to increase or decrease the phase angle output to the controls 18 as necessary to provide more or less power to the motor 10 to compensate for torque applied to the motor 10 and sensed by the circuit 20.

Alternate embodiments may be utilized. For example, as shown in FIG. 6, the sample and hold circuit 28 may supply the reference voltage to a voltage controlled oscillator 60. As the reference voltage increases or decreases, the voltage controlled oscillator 60 outputs a square wave with varying frequency. This square wave may be supplied to an input pin of the microcontroller 16 and may determine whether torque is increasing or decreasing based upon the frequency.

The sample and hold circuit 28 is advantageous in that it stabilizes voltage information across the load resistor 28 (i.e., voltage drop changes are smoothed). In addition, the sample and hold circuit 28 provides information about the voltage drop in the form of a DC voltage, which may be supplied to the comparator 40 or the voltage controlled oscillator 60. If desired, a sample and hold circuit may be utilized without a voltage supply V1. As such, the comparator, voltage controlled oscillator, or output device would be configured to handle the voltage reading directly from the sample and hold circuit.

For both embodiments previously described, feedback is provided regarding the torque on the electric motor 10 without the need for an analog to digital converter on the microcontroller 16. Thus, the expense of the circuit 20 is minimized. If desired, however, as shown in FIG. 7, the sample and hold circuit 28 may be attached to a microcontroller 70 having an analog to digital controller 72. While such an embodiment does not take advantage of the cost savings of the circuits of FIGS. 2 and 6, the microcontroller 70 may be programmed to relay voltage increases or decreases to the power controller without need for an additional device.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A motor, comprising:
AC input;
windings connected to the AC input and configured to receive a current from the AC input;
a load resistor mounted in series with the windings; and
a sample and hold circuit connected to the load resistor and configured to sample and hold first voltage drop information representing a voltage drop across the load resistor.

2. The motor of claim 1, further comprising an output device connected to the sample and hold circuit, the output device configured to generate a varying signal based upon changes the first voltage drop information.

3. The motor of claim 2, wherein the output device comprises a voltage controlled oscillator.

4. The motor of claim 2, wherein the output device comprises a comparator.

5. The motor of claim 4, wherein the comparator is coupled to the sample and hold circuit and a fixed charge circuit.

6. The motor of claim 5, wherein the comparator is configured to send a pulse to a microcontroller upon a voltage of the fixed charge circuit equaling a value related to the first voltage drop information.

7. The motor of claim 6, wherein the comparator is configured to send a pulse to the microcontroller upon a voltage of the fixed charge circuit equaling the first voltage drop information.

8. The motor of claim 7, wherein the microcontroller is configured to discharge the fixed rate charging circuit as a result of receiving the pulse.

9. The motor of claim 6, wherein the microcontroller is configured to discharge the fixed rate charging circuit as a result of receiving the pulse.

10. The motor of claim 1, further comprising:
a microcontroller connected to the sample and hold circuit and configured to receive the first voltage drop information; and
a power controller configured to receive instructions regarding speed control for the motor from the microcontroller, the instructions based upon the first voltage drop information.

11. A motor, comprising:
AC input;
windings connected to the AC input and configured to receive a current from the AC input;
a load resistor mounted in series with the windings;
a sample and hold circuit connected to the load resistor and configured to sample. and hold first voltage drop information representing a voltage drop across the load resistor;
a comparator connected at a first input to the sample and hold circuit and having a second input;
a fixed rate charging circuit connected to the second input;
the comparator being configured to generate a pulse as a result of a voltage of the fixed rate charging circuit reaching a voltage level that is related to the first voltage drop information;
a microcontroller connected to the comparator and configured to receive the pulse and to discharge the fixed rate charging circuit as a result of receiving the pulse; and
a power controller configured to receive instructions regarding speed control for the motor from the microcontroller, the instructions based upon the frequency of pulses received by the microcontroller.

12. The motor of claim 11, wherein the comparator is configured to send a pulse to the microcontroller upon a voltage of the fixed charge circuit equaling the first voltage drop information.

13. The motor of claim 11, wherein microcontroller receives the pulse independent of an analog to digital converter.

14. A motor, comprising:
AC input;
windings connected to the AC input and configured to receive a current from the AC input;
a load resistor mounted in series with the windings;
a sample and hold circuit connected to the load resistor and configured to sample and hold first voltage drop information representing a voltage drop across the load resistor;
a voltage controlled oscillator connected to the sample and hold circuit and configured to output a square wave that varies in frequency in accordance with changes in the first voltage drop information;
a microcontroller connected to the voltage controlled oscillator and configured to receive the square wave; and
a power controller configured to receive instructions regarding speed control for the motor from the microcontroller, the instructions based upon the frequency of square wave received by the microcontroller.

15. The motor of claim 14, wherein microcontroller receives the pulse independent of an analog to digital converter.

16. A motor controller, comprising:
a load resistor configured to be mounted in series with windings of a motor; and
a sample and hold circuit connected to the load resistor and configured to sample and hold first voltage drop information representing a voltage drop across the load resistor.

17. The motor controller of claim 16, further comprising an output device connected to the sample and hold circuit, the output device configured to generate a varying signal based upon changes the first voltage drop information.

18. The motor controller of claim 17, wherein the output device comprises a voltage controlled oscillator.

19. The motor controller of claim 17, wherein the output device comprises a comparator.

20. The motor controller of claim 19, wherein the comparator is coupled to the sample and hold circuit and a fixed charge circuit.

21. The motor controller of claim 20, wherein the comparator is configured to send a pulse to a microcontroller upon a voltage of the fixed charge circuit equaling a value related to the first voltage drop information.

22. The motor controller of claim 21, wherein the comparator is configured to send a pulse to the microcontroller upon a voltage of the fixed charge circuit equaling the first voltage drop information.

23. The motor controller of claim 22, wherein the microcontroller is configured to discharge the fixed rate charging circuit as a result of receiving the pulse.

24. The motor controller of claim 21, wherein the microcontroller is configured to discharge the fixed rate charging circuit as a result of receiving the pulse.

25. The motor controller of claim 16, further comprising:
a microcontroller connected to the sample and hold circuit and configured to receive the first voltage drop information; and
a power controller configured to receive instructions regarding speed control for the motor from the microcontroller, the instructions based upon the first voltage drop information.
